(19) United States
(12) Patent Application Publication
(10) Pub. No.: US 2009/0171562 A1
(43) Pub. Date: Jul. 2, 2009

(54) Navigation System

(76) Inventor: Yasuyuki Shimada, Tokyo (JP)

Correspondence Address: BIRCH STEWART KOLASCH & BIRCH, PO BOX 747, FALLS CHURCH, VA, 22040-0747, US

(21) Appl. No.: 12/308,090

(22) PCT Filed: Apr. 26, 2007
(86) PCT No.: PCT/JP2007/059092

§ 371 Date: Dec. 5, 2008

(30) Foreign Application Priority Data
Jul. 6, 2006 (JP) 2006-186941

(51) Int. Cl. G01C 21/00

(52) U.S. Cl. 701/201

(57) ABSTRACT

A navigation system includes a map data acquisition means 11 for acquiring map data; a current position detection means 13 for detecting the current position of a mobile unit; an operation means 14 for inputting the destination thereof; a route search means 160 for searching a guide route from the place of departure to the destination inputted by the operation means based on the map data; and route guide means 18-21 for guiding a user while showing the current position on the found guide route, wherein the navigation system further includes route registration means 161, 162 for registering the move route of the mobile unit generated based on the trajectories in the past as learning data, and wherein the route search means, when the mobile unit is judged to have deviated from the guide route during the route guide, selects the learning data corresponding to the run conditions from the learning data registered in the route registration means and makes a guide route search again by applying the selected learning data.

### TECHNICAL FIELD

The present invention relates to a navigation system for guiding a user to a destination along a guide route provided by route search and in particular to a technology for excellently guiding the user after deviation from the guide route.

### BACKGROUND ART

In a conventional navigation system having a route guidance function, the following techniques are known: tracks traveled in the past (trajectories) are stored, and then the stored trajectories are reflected in route search so that a route to be guided for a user can be provided with a more appropriate guide route.

For example, Patent Document 1 discloses a moving object navigation system storing a differential route reflecting a difference between the move route of a mobile unit or moving object and a guide route as learning data and capable of providing a practical route matched to the user's taste by applying the learning data to the guide route search. The moving object navigation system extracts the move route of the moving object, extracts the differential route different from the guide route from the extracted move route to register the differential route, and applies the registered differential route to the guide route search made thereafter.

Further, Patent Documents 2 and 3 disclose a navigation system for a vehicle capable of guiding a user along a route according to the user's preference. The navigation system for a vehicle registers places of departure, destinations, and a plurality of traveled routes by linking them with each other. When the inputted place of departure and destination is within a predetermined range from the place of departure and destination of the registered route, the navigation system presents a plurality of routes to a user to be selected, or selects a route such that the time represented by the use time information registered together with the route is the nearest to the current time, and then guides the user along the selected route.

Patent Document 1: JP-A-2002-310699

Patent Document 2: JP-A-2004-226275

Patent Document 3: JP-A-2004-226312

However, in the aforementioned conventional navigation systems, when a plurality of routes are registered, there may occur a situation where the system selects the route, not intended by the user, to be guided; thus, the improvement thereof is desired. Further, there is a problem such that the conventional navigation systems are inferior in ease of operation since the user must perform an operation to select a route suitable for reaching the destination by comparing a plurality of designated routes with each other.

The present invention has been made to meet the above-described demands and solve the above problems, and an object of the invention is to provide a navigation system capable of showing a route fitted to the user's taste, and further, excellent in operability.

### DISCLOSURE OF THE INVENTION

In order to solve the above-mentioned problems, the navigation system according to the present invention includes: a map data acquisition means for acquiring map data; a current position detection means for detecting the current position of a mobile unit; an operation means for inputting the destination thereof; a route search means for searching a guide route from a place of departure to a destination inputted by the operation means based on the map data acquired by the map data acquisition means; and a route guide means for guiding a user while presenting the current position detected by the current position detection means on the guide route found by the route search means, wherein the navigation system further comprises a route registration means for registering the move route of the mobile unit generated based on the traveled tracks or trajectories in the past as learning data, and wherein the route search means, in the event that a deviation from the guide route during the route guide by the route guide means is determined, selects the learning data corresponding to the run conditions thereof from the learning data registered in the route registration means and searches a guide route again by applying the selected learning data.

According to the navigation system of the present invention, it is configured that the move routes of the mobile unit generated based on the trajectories in the past are registered as learning data, and that in the event that the deviation from the guide route during the route guide is determined, the learning data corresponding to the run conditions is selected from in the registered learning data and a guide route is searched again by applying the selected learning data, whereby the routes on which the user has run in the past, in other words, the routes intended by the user are provided as the guide route. Therefore, the route fitted to the user's taste can be provided. Further, the user does not have to compare a plurality of displayed routes to select a route suitable for the destination, and thus, the navigation system is excellent in operability.

### BRIEF DESCRIPTION OF THE DRAWINGS

FIG. 1 is a block diagram showing the functional configuration of a navigation system in accordance with a first embodiment of the present invention.

FIG. 2 is a block diagram showing the hardware configuration of the navigation system in accordance with the first embodiment of the present invention.

FIG. 3 is a flowchart showing the operations of the navigation system in accordance with the first embodiment of the present invention.

FIG. 4 is an explanatory diagram showing the operations of the navigation system in accordance with the first embodiment of the present invention.

FIG. 5 is a flowchart showing the operations of a navigation system in accordance with a second embodiment of the present invention.

FIG. 6 is an explanatory diagram showing the operations of the navigation system in accordance with the second embodiment of the present invention.

### BEST MODE FOR CARRYING OUT THE INVENTION

Embodiments of the present invention will now be described with reference to the accompanying drawings in order to explain the present invention in more detail.

### First Embodiment

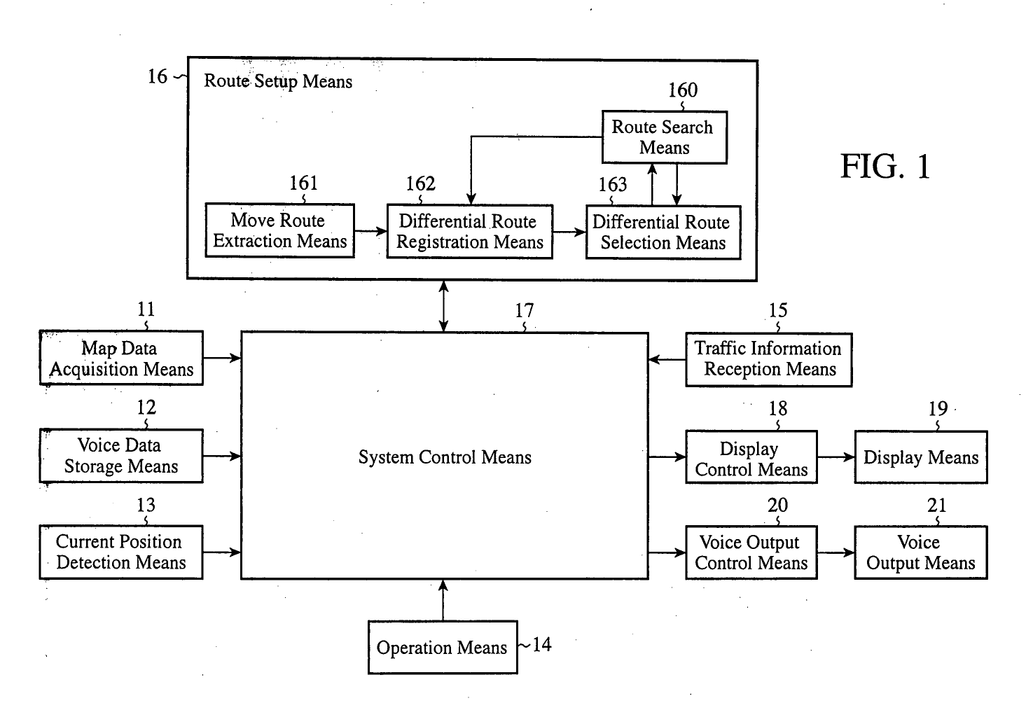

FIG. 1 is a block diagram showing the functional configuration of a navigation system in accordance with a first embodiment of the present invention. The navigation system is composed of a map data acquisition means 11; a voice data storage means 12; a current position detection means 13; an operation means 14; a traffic information reception means 15; a route setup means 16; a system control means 17; a display control means 18; a display means 19; a voice output control means 20; and a voice output means 21.

The map data acquisition means 11 acquires map data including road data or the like representing roads where a vehicle travels. The map data acquisition means 11 includes a storage means (not shown) storing the map data, and may be configured to acquire the map data from the storage means. Alternatively, the map data acquisition means 11 may also be configured to acquire the map data from an external system, e.g., by using a communication system. The map data acquired by the map data acquisition means 11 is transmitted to the system control means 17.

The voice data storage means 12 stores voice guide messages for guiding the travel of a vehicle as voice data. The voice guide messages are stored therein by dividing each of the messages into a fixed phrase voice prepared for each type of the voice guides and a word voice prepared for specific sounds such as distances and names of places, and a combination of the fixed phrase voice and word voice enables a desired voice to be produced. The voice data stored in the voice data storage means 12 is read out by the system control means 17.

The current position detection means 13 detects the current position of the vehicle and the moving direction thereof, and sends them to the system control means 17 as current position data. The operation means 14 is used to input a destination at the time of route settings, and to input a variety of instructions to the navigation system through user operations. The operation data generated by operating the operation means 14 is transmitted to the system control means 17. The traffic information reception means 15 receives the traffic information transmitted from an external system, and sends the information to the system control means 17 as traffic data.

The route setup means 16 searches a route from the place of departure (the current position detected by the current position detection means 13 or the point inputted by the operation means 14) to the destination inputted by the operation means 14, and stores the found route therein as a guide route. The route setup means 16 is composed of a route search means 160, a move route extraction means 161, a differential route registration means 162, and a differential route selection means 163. The move route extraction means 161 and differential route registration means 162 correspond to the route registration means of the present invention.

The route search means 160 searches the optimum route from the current position shown by the current position data sent from the current position detection means 13 through the system control means 17 to the destination shown by the operation data sent from the operation means 14 through the system control means 17, and then stores the found route in a self-storage as the guide route. The stored guide route is sent to the differential route selection means 163 and differential route registration means 162, and transmitted to the system control means 17. The system control means 17 sends the guide route received from the route search means 160 to the display means 19 through the display control means 18, and causes the display means to display the guide route. Moreover, the system control means 17 reads out the voice data from the voice data storage means 12 based on the guide route received from the route search means 160, and sends the voice data to the voice output control means 20. In this way, a voice guide message is output from the voice output means 21.

The move route extraction means 161 calculates the trajectory of the vehicle based on the current position shown by the current position data sent from the current position detection means 13 through the system control means 17 and the map data sent from the map data acquisition means 11 through the system control means, and extracts the trajectories of the vehicle based on the calculation result. The move route extracted by the move route extraction means 161 is transmitted to the differential route registration means 162.

The differential route registration means 162 extracts a portion reflecting a difference between the move route sent from the move route extraction means 161 and the guide route sent from the route search means 160, namely, the differential route therebetween, and registers the differential route therein as learning data. The registered differential route is sent to the differential route selection means 163. Note that the details of the extraction and registration of the differential routes (learning data) are discussed in the above-described Patent Document 1. See the document as required.

The differential route selection means 163 selects the optimum route for the run conditions at that time from among a plurality of differential routes registered by the differential route registration means 162, and sends the route to the route search means 160. In such a way, the route search means 160 applies the differential route sent from the differential route selection means 163 to make a route search again, and calculates a guide route. The calculated guide route is sent to the system control means 17.

The system control means 17 controls all the operations of the navigation system by carrying out a predetermined process to the data sent from the map data acquisition means 11, voice data storage means 12, current position detection means 13, operation means 14, traffic information reception means 15, and route setup means 16.

The display control means 18 generates display signals for displaying the roadmaps, current position mark, destination mark, guide route, and so on according to commands or instructions from the system control means 17, and sends the signals to the display means 19. The display means 19 displays the roadmap, the current position mark, destination mark, guide route, and so on in accordance with the display signals sent from the display control means 18. The display control means 18 and display means 19 correspond to the route guide means of the present invention.

The voice output control means 20 generates the voice signals to output the voice guide message based on the voice data read out from the voice data storage means 12 according to commands from the system control means 17, and sends the signals to the voice output means 21. The voice output means 21 outputs voice in accordance with the voice signals sent from the voice output control means 20. The voice output control means 20 and the voice output means 21 correspond to the route guide means of the present invention.

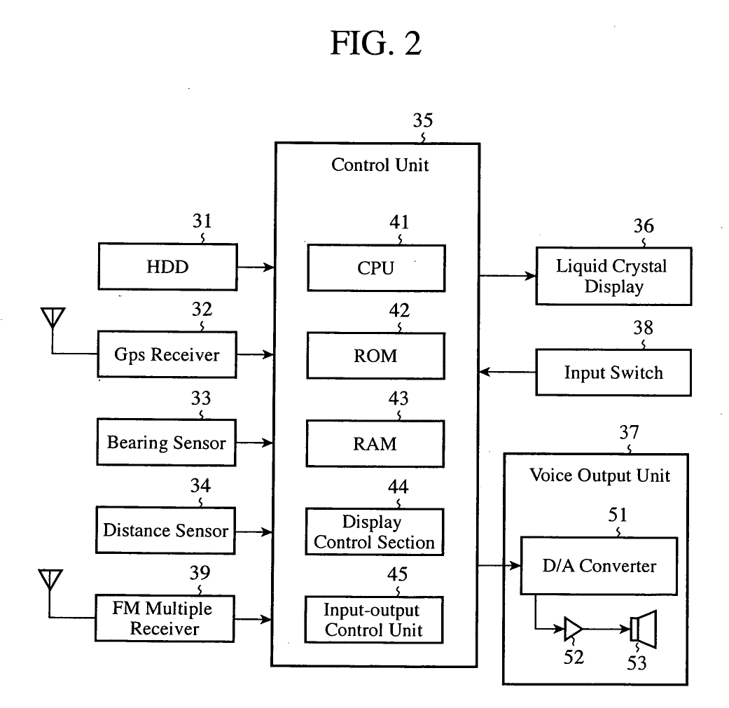

The hardware configuration in accordance with the first embodiment will be discussed with reference to the block diagram shown in FIG. 2.

The navigation system is composed of a HDD (Hard Disk Drive) 31, GPS (Global Positioning System) receiver 32, bearing sensor 33, distance sensor 34, control unit 35, liquid crystal display 36, voice output unit 37, and input switch 38. The HDD 31 corresponds to the map data acquisition means 11 and voice data storage means 12 shown in FIG. 1, and stores the map data and voice data. The map data and voice data stored in the HDD 31 are read out by the control unit 35.

The GPS receiver 32 receives radiowave from the GPS satellite to detect the current position of the vehicle. The current position detected by the GPS receiver 32 is sent to the control unit 35 as GPS data. The bearing sensor 33 detects the vehicle's bearing showing the moving direction of the vehicle. The vehicle's bearing detected by the bearing sensor 33 is sent to the control unit 35 as bearing data. The distance sensor 34 detects the travel distance of the vehicle. The travel distance thereof detected by the distance sensor 34 is sent to the control unit 35 as distance data. Those GPS receiver 32, bearing sensor 33, and distance sensor 34 correspond to the current position detection means 13 shown in FIG. 1.

The control unit 35 controls various calculations and the operations of the whole navigation system. The operations of the route setup means 16, system control means 17, display control means 18, and voice output control means 19 shown in FIG. 1 are realized by the control unit 35. The control unit 35 includes a CPU (Central Processing Unit) 41, ROM (Read Only Memory) 42, RAM (Random Access Memory) 43, display control section 44, and input-output control unit 45.

The CPU 41 operates with the RAM 43 as a work area according to the control program stored in the ROM 42, whereby the CPU realizes the operations of the above-mentioned route setup means 16, system control means 17, display control means 18, and voice output control means 19. In addition, the RAM 43 is also used to store the differential route registered by the differential route registration means 162 shown in FIG. 1.

The display control section 44 is composed of, for example, a graphic board executing image processing at a high speed, and controls the display of the liquid crystal display 36. The input-output control unit 45 controls the transmission and reception of the signals between the control unit 35 and the external constituent elements (the HDD 31, GPS receiver 32, bearing sensor 33, distance sensor 34, liquid crystal display 36, voice output unit 37, and input switch 38).

The liquid crystal display 36 corresponds to the display means 19 shown in FIG. 1, and displays the roadmap, the current position mark, the destination mark, the guide route, and so on according to the display signals sent from the control unit 35. Incidentally, the display means 19 is not limited to a liquid crystal display, and other various displays capable of displaying the roadmap and so on such as a CRT display unit, and a plasma display unit can be also used as the display means.

The voice output unit 37 corresponds to the voice output means 21 shown in FIG. 1, and outputs the voice guide messages according to the voice signals from the control unit 35. The voice output unit 37 includes a D/A converter 51, an amplifier 52, and a speaker 53. The D/A converter 51 converts the digital voice signals sent from the control unit 35 into the analog voice signals, and sends the signals to the amplifier 52. The amplifier 52 amplifies the analog voice signals from the D/A converter 51, and sends the signals to the speaker 53. In this way, the speaker 53 outputs the voice guide message, for instance.

The input switch 38 corresponds to the operation means 14 shown in FIG. 1, and is used to specify the destination and command the display to switch the screens displayed in the liquid crystal display 36. The operation means 14 is not limited to the input switch 38, and a remote controller, a touch panel, a voice input unit having the voice recognition function or the equivalent can be also used as the operation means.

An FM multiple receiver 39 corresponds to the traffic information reception means 15 shown in FIG. 1, and receives FM multiple broadcasts. The traffic information provided by the reception of the FM multiple broadcast by the FM multiple receiver 39 is sent to the control unit 35.

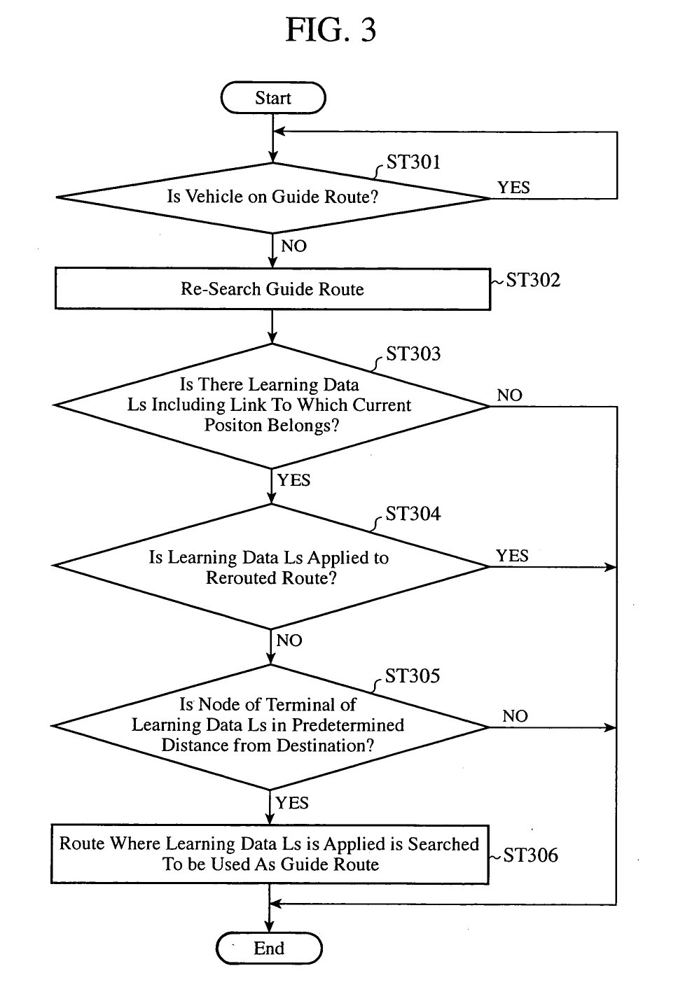

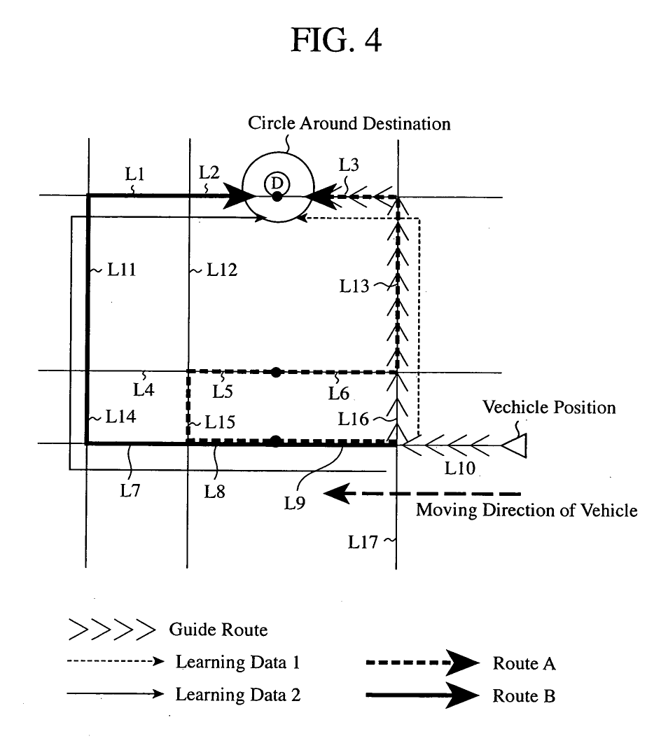

The operations of the navigation system in accordance with the first embodiment of the present invention arranged as described above will next be discussed mainly about the process in the case that the vehicle deviates from the designated guide route during a route guiding by referring to the flow chart shown in FIG. 3 and the explanatory diagram shown in FIG. 4.

Hereinafter, it is assumed that the first route search made by the route search means 160 has been completed, and the guide route to a destination D (link L10→L16→L13→L3) has been set as shown in FIG. 4. Further, it is assumed that learning data 1 (L16→L13→L3) and learning data 2 (link L9→L8→L7→L14→L11→L1→L2) have been registered as learning data by the differential route registration means 162.

First, the process checks whether or not the vehicle is on the guide route (step ST301). Specifically, the route setup means 16 checks whether or not the vehicle is on the guide route based on the current position data provided from the current position detection means 13 through the system control means 17 and the map data sent from the map data acquisition means 11 through the system control means. In the step ST301, when it is judged that the vehicle exists on the guide route, that is, it has not deviated from the guide route, the process enters a waiting state while repeatedly executing the step ST301.

In the waiting state where the step ST301 is repeatedly performed, when the vehicle is judged as an absence on the guide route, namely, a deviation therefrom, rerouting of the guide route is made again (step ST302). For example, in the example shown in FIG. 4, when the vehicle moves in the direction of the arrow shown by “Moving direction of the vehicle” and deviates from the guide route (proceeded from link L10 to link L9), the route search means 160 included in the route setup means 16 lowers the cost of the learnt links stored as the learning data (alternatively, the cost of links other than the learnt links may be raised), searches a route to the destination again, and stores the found route in the self-storage. In this way, the route shown by the learning data are set so as to be easily selected, thus making a route search.

Then, the process checks whether or not there is a learning data Ls including the link to which the current position belongs (step ST303). Specifically, the differential route selection means 163 checks whether or not the learning data containing the link L9 to which the current position belongs exists in the learning data registered by the differential route registration means 162 based on the current position and moving direction of the vehicle shown by the current position data sent from the current position detection means 13 through the system control means 17. In the step ST303, when it is judged that there is no learning data Ls including the link to which the current position belongs, it is recognized that the found route is the route the vehicle passes for the first time, and the process ends. Thereafter, the route found in step ST302 is provided to the user as the optimum guide route.

Otherwise, in the step ST303, when it is judged that there is the learning data Ls including the link to which the current position belongs, the process checks whether or not the learning data Ls (the learning data 2 in the example of FIG. 4) has been applied to the route which is searched again or rerouted in step ST302 (step ST304). Specifically, the differential route selection means 163 reads out the route that is found and stored by the route search means 106, and checks whether or not the route read out therefrom is the route shown by the learning data Ls. In the step ST304, when the learning data Ls is judged to have been applied to the route searched again, it is recognized that the route is the one matched to the user's taste, and the process finishes.

Meanwhile, in the step ST304, when the learning data Ls is judged not to have been applied to the route searched again in the step ST302, the process checks whether or not the node of the terminal of the learning data Ls exists within a predetermined distance from the destination D (step ST305). To be specific, the differential route selection means 163 checks whether or not the node of the terminal of the learning data Ls exists in the proximity of the destination D specified by the user (for example, within a radius of 500 meter from the destination). In the step ST305, when it is judged that the node of the terminal of the learning data Ls does not exist within a predetermined distance from the destination D, it is recognized that the route is the one passed by the vehicle for the first time, and the process ends. Thereafter, the route is provided to the user as the optimum guide route.

Otherwise, in the step ST305, when it is judged that the node of the terminal of the learning data Ls exists within a predetermined distance from the destination D, the route to which the learning data Ls is applied is searched, and the found route is provided as the guide route (step ST306). In other words, the route search means 160 makes a search for a route passes the learning data Ls and leading to the destination, and stores the found route in the self-storage as the guide route. The guide is performed by using the stored guide route afterward.

It should be noted that in the route search in step ST306, when there are a plurality of pieces of learning data Ls such that the node of the terminal exists within a predetermined distance from the destination D, it may be configured that a route search be made with the learning data Ls passed more frequently in the past, or the last passed learning data Ls. In this case, additional information indicating the number of times the vehicle has passed the route and the date and time when the vehicle passed the route is added to the learning data to be registered therein.

By the above-described process, in the example shown in FIG. 4, Route A (link L9→L8→L15 →L5→L6→L13→L3) is the first found guide route, Route B (link L9→L8→L7→L14→L11→L1→L2) is the guide route found in consideration of the moving direction of the vehicle; as a result, Route B is applied as the guide route. In such a way, a route fitted to the user's taste can be provided.

### Second Embodiment

The navigation system in accordance with a second embodiment of the present invention is configured such that a differential route is registered together with a route before deviating from a guide route. The functional configuration and hardware configuration of the navigation system in accordance with the second embodiment are the same as those of the navigation system in accordance with the first embodiment shown in FIG. 1 and FIG. 2, respectively. Therefore, explanation will be given mainly about the operations of the navigation system hereinafter.

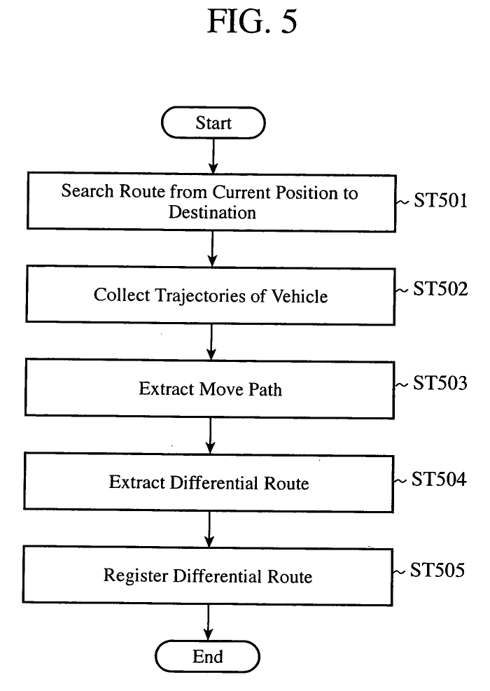

FIG. 5 is a flowchart showing the registration operations of the differential route in the navigation system in accordance with the second embodiment of the present invention.

First, a route from the current position of a vehicle to the destination thereof is searched for (step ST501). Specifically, the route search means 160 searches the optimum route from the current position shown by the current position data sent from the current position detection means 13 through the system control means 17 to the destination shown by the operation data sent from the operation means 14 by way of the system control means 17.

Then, the trajectories of the vehicle are collected (step ST502). Specifically, the move route extraction means 161 calculates the trajectories of the vehicle based on the current position data sent from the current position detection means 13 by way of the system control means 17 and the map data sent from the map data acquisition means 11 by way of the system control means, and collects the trajectories. Then, the move route is extracted (step ST503). Specifically, the move route extraction means 161 extracts the actual move route of the vehicle based on the trajectories collected in step ST502 and the map data sent from the map data acquisition means 11 by way of the system control means.

Subsequently, a differential route is extracted (step ST504) Specifically, the differential route extraction means 161 extracts the differential route different from the route found in step ST501 from the move route extracted in step ST503. Then, the differential route is registered (step ST505). That is, the differential route registration means 162 registers the differential route extracted in step ST504 together with the route before deviation from the guide route.

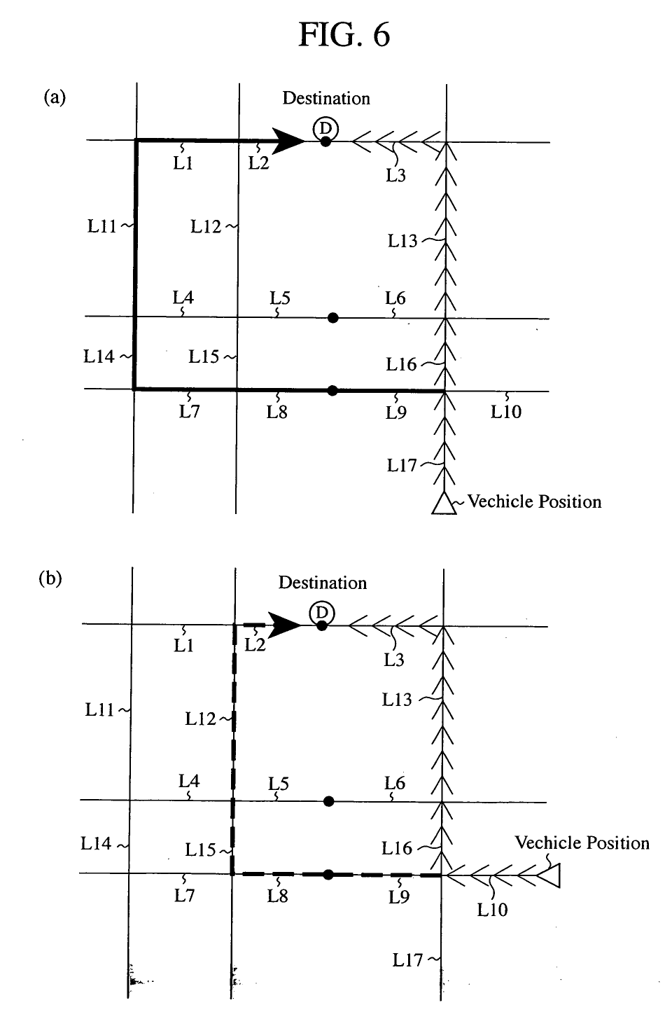

FIG. 6 is a diagram for explaining the route registered by the differential route registration means 162. FIG. 6 (a) shows the case where the guide route is link L17→L16→L13→L3, and the route where the vehicle actually ran is link L17→L9'L8→L7→L14→L11→L1→L2, and FIG. 6 (b) shows the case where the guide route is L10→L16→L13→L3, and the route where the vehicle actually ran is L10→L9→L8→L15→L12→L2.

In the example shown in FIG. 6 (a), the difference from the guide route is L9→L8→L7→L14→L11→L1→L2, and in the example shown in FIG. 6 (b), the difference from the guide route is L9→L8→L15→L12→L2. When only those differential routes are registered, the example shown in FIG. 6 (a) is the same as the example shown in FIG. 6 (b) in the starting point and the terminal of the differential route, and thus it is impossible to judge which differential route is more appropriate for the user in applying the registered differential route to the guide route.

For this reason, in the navigation system in accordance with the second embodiment of the present invention, when the differential route is registered, the difference route reflecting a difference between the routes as well as the route before deviation from the guide route (L17 in FIG. 6 (a) and L10 in FIG. 6 (b); however, the number of links can be properly changed) is registered. In such a way, the differential route selection means 163, when applying the registered differential route to the guide route, becomes capable of selecting the differential route to be applied in consideration of the moving direction of the vehicle, and thus, when the guide route is the route passing the link L17, the differential route shown in FIG. 6 (a) is applied to the guide route, and when the guide route is the route passing the link L10, the differential route shown in FIG. 6 (b) is applied to the guide route, respectively. This enables the route adjusted to the user's taste to be provided.

### INDUSTRIAL APPLICABILITY

As mentioned above, the navigation system according to the present invention is configured to register the move route of a mobile unit based on the trajectories in the past as learning data, and make a route search again by applying the registered learning data thereto according to the run conditions when the unit deviated from the guide route, whereby the navigation system can provide a route fitted to the user's taste, and is suitable for use in vehicle navigation systems or the like excellent in operability.

1-3. (canceled)

4. A navigation system comprising:
a map data acquiring means for acquiring map data shown by links;
a current position detecting means for detecting the current position of a mobile unit;
an operation means for inputting the destination thereof;
a route search means for searching a guide route from the place of departure to the destination composed of a plurality of link chains based on the map data;
a route guiding means for guiding while presenting the current position thereof by the current position detecting means on the guidance route found by the route searching means; and
a route registration means for registering the move route of the mobile unit which is generated based on trajectories traveled in the past and represented as the plurality of link chains as learnt data;
wherein in the event that a deviation from the guide route is determined during a route guide by the route guide means, the route search means reroutes for a guide route from the current position thereof to the destination, and
in the case where a plurality of pieces of learning data including the link to which the current position of the mobile unit belongs are contained in the learning data registered by the route registration means, and where the plurality of pieces of learning data contained therein have not been applied to the rerouted guide route, and further in the case where for the plurality of pieces of learning data contained therein, the terminal of the learning data exists within a predetermined distance from the destination, the route search means selects the learning data corresponding to the run conditions from in the plurality of pieces of learning data contained therein, and further searches again the guide route by applying the selected learning data.

5. The navigation system according to claim 4, wherein the learning data corresponding to the run conditions which is selected by the route search means is judged as the learning data passed more frequently in the past, or the last passed learning data.

6. The navigation system according to claim 4, wherein the current position detecting means detects the moving direction thereof, and
in the event that a deviation from the guidance route is determined during the route guide by the route guide means, the learning data selected by the route search means corresponds to the moving direction thereof detected by the current position detection means.
